(19) United States
(12) Patent Application Publication
(10) Pub. No.: US 2014/0260599 A1
(43) Pub. Date: Sep. 18, 2014

(54) THERMAL DISPERSION FLOW RATE SENSING TRANSDUCER

(71) Applicant: FLUID COMPONENTS INTERNATIONAL LLC, San Marcos, CA (US)

(72) Inventor: Malcolm M. MCQUEEN, Encinitas, CA (US)

(21) Appl. No.: 13/843,251

(22) Filed: Mar. 15, 2013

(51) Int. Cl. G01F 1/69

(52) U.S. Cl. CPC G01F 1/69
USPC 73/204.25

(57) ABSTRACT

A thermal dispersion flow rate sensing transducer for improved functional life of the transducer without degradation in sensing accuracy.

### FIELD OF THE INVENTION

This concept relates generally to thermal dispersion flow rate sensing transducers and, more particularly, to innovations which improve the performance of the transducer in terms of accuracy, response time, cost, and power consumed, durability, repeatability from instrument to instrument, and repeatability of the same instrument over time generally referred to as “drift.”

### DISCUSSION OF THE PRIOR ART

Thermally-based fluid flow and level transducers or sensors employ the well-known and long established principle that a heated sensor will have different characteristics with temperature changes. A resistance temperature detector (RTD) will have a temperature change as the ambient temperature of the fluid in which the sensor is immersed or the velocity of fluid past the sensor draws heat away from the sensor. Thus, a heated sensor in liquid or in a flowing gas will give up some of its heat to the fluid. That creates measurable changes in the resistance of an RTD as a function of the fluid and the flow-rate or interface from fluid to fluid or to gas. An early such transducer is shown in U.S. Pat. No. 3,898,638. For reference purposes, there are two variations in the structure and manner of operation of such sensors. As shown in the '638 patent, one thermal well functions as a heater to heat the nearby active sensor. A third thermal well is a reference or inactive sensor and is far enough from the heater to not be affected by the heat and measures the media temperature. The other, and now more common type, is the self-heated transducer. This device may function on a time-shared basis or it may simply be self-heated and the amount of heat dissipated by the fluid is measured by appropriate means. A time-shared RTD heats itself when extra current is applied and then is cooled by the contacting fluid when the heat current is removed and thereby eliminate the need for a second, unheated RTD or so called reference sensor.

Such RTD sensors or thermal wells are normally quite small, in the order of 0.062 to 0.118 inch in diameter, and a small fraction of an inch long. Those are exemplary dimensions of the RTD of a transducer. Inside the thermal well is the actual sensing element, typically a solid state RTD, near the distal end of the device. The RTD element and its attendant communication wires lead out the proximal end from the RTD and the rest of the inside of the thermal well is filled with potting material. However, in general and industry-wide, the needed potting in the transducer has been a problem owing to changes in the heat transfer paths in the potting material, be it polymer, thermal grease, ceramic, or other material or means of mounting.

Variations in potting material and consistency are a handicap for repeatability from unit to unit. Degradation or other changes in the potting compound results in unpredictable changes in heat transfer characteristics of the sensor over time and temperature. FIG. 1 shows a large variation in the amount of potting uses, even in the same instrument. It has been exaggerated to make the point and it is also illustrative of the variations in the amount of potting from unit to unit and is typical of current transducers of this type.

Consistency is, in fact, a bigger problem in that air bubbles are often entrained in the assembly process when potting material is placed in the thermal well and the RTD and its assembly of two bore ceramic tubing and stranded copper leads are immersed in the semi-liquid potting material.

Also “pot life” of the potting material is a factor in that if the potting material pot life is at or near an end, the amount of entrained air increases, as does the thermal resistance of the cured potting. Again, air entrainment varies and a small bubble of air can cause much higher temperatures in the RTD, thereby introducing significant variations in the accuracy calibration to follow.

The same problem exists when a separate heater is used instead of self-heated RTDs. Coaxial heaters, as now used in some later model instruments, are superior to earlier models wherein a separate heater was placed in an adjacent and thermally bonded thermal well where wells are fused together to promote heat transfer. This has been a significant problem because there were frequently multiple heat transfer paths as well as thermal variations in the fused joint affecting the unit-to-unit repeatability and the long term stability of the heat transfer paths.

Curing the potting material provides another instantaneous problem in that thorough curing of the polymer or ceramic potting is necessary. Partially cured units will change their calibration in a few days or even in several months after it is manufactured and calibration tests have been completed and this will also negatively affect the accuracy in service as compared to the calibration curves established for and sent to the user with the units.

As for particular types of potting material which have been employed in such thermal transducers, thermal grease dries out and turns to powder after several years of service, thereby causing a higher temperature to occur in the heated sensor. This change has serious consequences for in-service accuracy and response time.

Finally to try to prevent the above problems, a method has evolved for pressurizing the thin wall thermal well onto the within elongated cylindrical wire-wound RTD (FIG. 3A). The problem with this method is when the hydro forming pressure is removed, the metal bounces back and thereby loosens the RTD which could subsequently move under service conditions. Low electrical resistance is still another handicap to this scheme, among others.

Ceramic can shrink over time or crack repeatedly with temperature cycling, or both. Both conditions lead to air gaps and, again, accuracy and response time deviations.

Polymers such as epoxy and silicone-based plastics degrade and age with temperature and time. Changes occur in the heat transfer coefficients causing like changes in accuracy, among other effects.

In addition to thermal transducer inaccuracies resulting from potting problems as set out above, there are other sources of sensor output inaccuracies. Variations in the ambient temperature and heat transfer conditions have been a source of error. When required to function in extreme weather conditions, where temperatures may range from as low as −65° F. to as high as +150° F., and severe wind also affects the ambient extremes, a conventional thermal sensor will be subject to erroneous output directly related to such conditions.

Apart from the ambient thermal conditions above, errors in sensor output may not be permanent and some of them may be ameliorated by recalibration. However, if recalibration is frequently required, the trust in the output of the sensor, and its operational value, are severely diminished. Depending upon the equipment and circumstances, recalibration may entail a significant disruption of an important process.

Since the subject matter here is thermal sensors it is generally conceded that accurate temperature measurement is one of the most difficult physical measurements to make. Volts, amps, weight, length, area, volume, density, and time are all comparatively easy dimensions to measure. The problem is compounded in flow switches and transmitters, and liquid-to-liquid interface sensors, because what is being measured are heat transfer rates, which is a much more difficult measurement than temperature alone. Accurate temperature sensing, as above, is difficult but a necessary component of heat transfer measurement. A second major part is the accurate and unchanging properties of the possibly multiple heat transfer paths.

Relatively thick walls of the metal thermal wells and conductivity (thermal) from the RTDs to the variations in temperature of surfaces produces errors in the accurate temperature sensing of the RTDs or other suitable temperature sensors such as thermocouples, among others.

Conductivity along the stranded copper lead wires from the short but fine RTD lead wires is another source of error. This is particularly the case with short platinum lead from the RTDs as they are connected to the stranded copper leads.

At least one supplier of these devices measures the effect of the above conductive effects and electronically compensates for the error otherwise caused. A different method is herein taught in that the conductive heat transfer is eliminated or suppressed to an infinitesimal value.

### SUMMARY OF EMBODIMENTS OF THE INVENTION

A purpose of the disclosed embodiments eliminates the need for potting of the RTD element or pressure forming the containing thermal wells. Additionally, it substitutes a precision unchanging reproducibility thermal path or joint between the RTD and the mounting surface of the thermal well in which the RTD is mounted. The precision, reproducible, and unchanging heat transfer path of the structure disclosed provides for consistent performance under all likely hostile service conditions so far as accurate, durable, and reproducible gas or fluid mass flow rate output, and interface sensing on non-liquids or slurries is concerned.

A solid state RTD sensor is secured in the sensing or distal end of a typical elongated thermal well to provide efficient thermal conductivity from the end of the thermal well exposed to the media of interest to the RTD.

The structure for the RTD wires to be connected externally to the usual flow rate indicators is also configured to minimize heat conduction which could affect the accuracy of the RTD signals.

Further, the thermal well proximal end and connection to typical mounting means is also configured to minimize unwanted heat transference otherwise related to the RTD signal and the fluid flow being sensed by employing long thin poorly conductive metal thermal wells. The thin thermal wells are internally supported by closely filling ceramic tubes.

### BRIEF DESCRIPTION OF THE DRAWING

The objects, features, and advantages of the concept disclosed herein will be more readily perceived from the following detailed description, when read in conjunction with the accompanying drawings, in which:

FIG. 1A is an enlarged sectional side view of a prior art thermal sensing transducer set;

FIG. 1B is a sectional view of the ceramic insulator of FIG. 1;

FIG. 2 is an enlarged sectional side view of a transducer in accordance with an embodiment of the invention;

FIG. 3 is a sectional end view taken along cutting plane 3-3 of FIG. 2;

FIG. 3A is a sectional view of hydro formed RTD/thermal well (prior art);

FIG. 4 is a partial sectional view of a modified proximal end of the thermal well of FIG. 2;

FIG. 5 is an alternative embodiment of the proximal end of the thermal well; and

FIG. 6 is another example of other means for RTD isolation from external thermal effects.

### DETAILED DESCRIPTION OF EMBODIMENTS OF THE INVENTION

In the prior art of FIG. 1, thermal well 11 has RTD sensor element 12 therein. The RTD wires 13 are connected to stranded copper wires 14 and fed out proximal end 15 of the thermal well to appropriate signal receivers. The thermal well is partially filled with potting 16.

Adjacent thermal well 21 of the same installation is similarly constructed. It is frilly filled with potting 22, out to proximal end 23. A ceramic positioner 24 is shown in this example.

The two thermal wells are mounted in wall 25, which may be a bracket or the wall of a conduit or container.

According to an embodiment of the invention, FIG. 2 shows thermal well 31 having sensing end 32. Most of the length 33 of the thermal well is of reduced wall thickness. RTD 34 is secured to the inside of end 32.

The RTD is precision pre-tinned with high temperature solder 35 (585±5° F. fusion temperature) and is soldered down in a 600° F. salt bath, for example. The precision pre-tinning RTD produces relatively equal heat transfer paths from unit to unit and possibly eliminates the need for individual calibration of each switch and possibly the transmitter at ±3% accuracy. RTD wires 37 pass through bore 38.

Four-bore thermal insulator 35 occupies a significant portion of the inside of thermal well 33. The thin wall long thermal well is physically supported by the four-bore insulator 35 and isolates the RTD at its distal end from the environmental effects at the base or proximal end 36. The thermal well, normally made from stainless steel, is a poor conductor of heat as far as metals are concerned. By making well 33 extra thin, even less heat is conducted from one end to the other.

Should it become necessary, optional heat sink fin 51 (FIG. 5) can be used. Alternatively to the fin, bellows 56 (FIG. 4) could be used for heat dissipation and could be hydro formed from the thin wall thermo well tube. These devices act as a thermal isolator by causing the local structure to be thermally anchored to local process temperature and further isolating the RTD from the environmental effects. The long four-bore insulator supports the extended lead wires 37 thermally communicating with the very core of the RTD. This configuration further isolates the RTD from the environmental thermal changes. Electrical insulator 35 is also an excellent mechanical support as well as being a thermal insulator and will effectively carry no heat away from the RTD owing to its own thermal properties and to the deliberately caused 0.002 to 0.004 inch air gap bores formed during final assembly post-soldering.

FIG. 6 is representative of other means of thermally isolating the RTD from environmental thermal effects. Not shown, but the normal piping and female threaded adapter could be insulated as well as the (not shown) housing to which the wetted sensor element is attached. Several other methods could be employed.

### ADVANTAGES OF THE DISCLOSED EMBODIMENTS WITH RESPECT TO THE PRIOR ART

The metal heat transfer paths and RTD mounting means are completely stable and unchanging with time, temperature, and other service related conditions through the elimination of the potting material and other known techniques.

The solder method of mounting permits the use of pre-tinned, highly electrically resistant, inexpensive stable thin film chip for use at 350° F. or higher and at lower costs and enhanced performance.

Various fins or torturous heat transfer paths help to isolate the RTD from hostile environmental thermal effects and thereby improves the performance.

What is claimed is:

1. A thermal dispersion flow rate and interface sensing transducer for media, comprising:
an elongated thermal well having a distal end configured to be in the media to be sensed, said distal end being of a first thickness, the majority of the length of said thermal well being of reduced thickness;
a thermally insulative element having a distal end spaced from said thermal wall distal end and occupying and supporting the interior space of said reduced thickness portion of said thermal well, said insulative element having longitudinal bores therethrough;
a solid state resistance thermal detector (RTD) on the inside face of the end of said thermal well;
solder securing said RTD to said thermal well inside face; and
RTD signal wires extending from said RTD through at least one bore in said insulative element and out the proximal end of said thermal well.

2. The transducer of claim 1, and further comprising:
potting material encasing the proximal end of said thermal wall; and
external lead wires extending into said material, said RTD lead wires electronically engaging said external lead wires within said material.

3. The transducer of claim 1, and further comprising a heat sink on the outside of said thermal well.

4. The transducer of claim 1, wherein a portion of the proximal end of said thermal well wall is formed as a bellows for heat dissipation.

5. Other devices to isolate said RTDs from external or ambient thermal conditions.
